(19) United States
(12) Patent Application Publication
(10) Pub. No.: US 2004/0267556 A1
(43) Pub. Date: Dec. 30, 2004

(54) News subscription method

(76) Inventor: Stephen C. Larson, Clifton Springs, NY (US)

Correspondence Address: STEPHEN C. LARSON, 17 PLEASANT ST., CLIFTON SPRINGS, NY, 14432, US

(21) Appl. No.: 10/610,062

(22) Filed: Jun. 30, 2003

(51) Int. Cl. G06F 17/60

(52) U.S. Cl. 705/1; 705/14

(57) ABSTRACT

The present invention provides a business method allowing for newspapers to expose archival content to popular search engines and to prevent revenue loss from users utilizing the free newspaper content provided by public libraries by allowing free access to archival content and charging a fee for recent content.

### CROSS-REFERENCE TO RELATED APPLICATIONS

The present invention relates to a business method allowing for newspapers to expose archival content to popular search engines and to prevent revenue loss from users utilizing the free newspaper content provided by public libraries by allowing free access to archival content and charging a fee for recent content.

The present application is futher related to U.S. application, “SYSTEM AND METHOD FOR INCORPORATION OF PRINT-READY ADVERTISEMENT IN DIGITAL NEWSPAPER EDITIONS”, LARSON, Ser. No. 092674, SERIES CODE: 10, FILED: Mar. 7, 2002 and to U.S. application, “METHOD AND APPARATUS TO DISPLAY PAPER-BASED DOCUMENT ON THE INTERNET”, LARSON, application Ser. No. 10/404,499, FILED Apr. 1, 2003.

### BACKGROUND

Modern newspapers are struggling to redefine themselves now that the Internet provides an inexpensive means for publication. According to the web site owned and maintained by Caslon Analytics Pty Ltd, of Australia, Analysphere.com, the business model of offering free Internet content and supporting the cost by advertisements has failed. They suggest a solution comprising of charging a fee for archived content (older content) while only offering for free headlines and teaser items. The concept of charging a fee for archival content and offering only selected headlines for free has been adopted world-wide with international papers such as the Australian Financial Review, the London Times, the Financial Times, and the South China Morning Post adopting this model.

There are two problems arising from this model. First, public libraries offer archival content from local and national libraries for free. Therefore, a user can bypass paying for archival content by simply obtaining a library card.

The second problem created by this model is that the archival information becomes hidden behind a firewall. Popular search engines will not have access to the information and will fail to provide users with the information about the articles existence and the newspaper will potentially lose customers.

There is a need therefore for a business method allowing for newspapers to expose archival content to popular search engines and to prevent revenue loss from users utilizing the free newspaper content provided by public libraries.

### SUMMARY OF THE INVENTION

The present invention is directed at overcoming the problems set forth above. In particular, the present invention provides a business method allowing for newspapers to expose archival content to popular search engines and to prevent revenue loss from users utilizing the free newspaper content provided by public libraries by allowing free access to archival content and charging a fee for recent content.

### DETAILED DESCRIPTION OF THE INVENTION

The present invention provides a business method allowing for newspapers to expose archival content to popular search engines and to prevent revenue loss from users utilizing the free newspaper content provided by public libraries by allowing free access to archival content and charging a fee for recent content.

Newspapers are engaged in the publication of news, opinions, and curiosities associated with local, national and global events. By the term “recent content” it is meant: publications created within a defined time interval occurring before the current time. By “archival content”, it is meant all other content published or, equivalently, content published on or before recent content.

To practice the present invention it is recommended that some thought be given to the time interval that defines the boundary between archival and recent content. In a preferred embodiment, it is recommended that newspaper management poll newspaper readers regarding how much they would pay for recent content over a continuum of the time intervals that define recent content in comparison to archival content. Newspaper managers can then construct demand curves as a function of price and time interval to maximize their profit.

Once the time interval is defined, the web site need to be constructed such that the archival content lies outside the firewall and available to the public. Recent content should be stored inside the firewall, available to users that have paid a fee or equivalently paid for a subscription.

Refer to FIG. 1. To determine whether content 30 is recent or archival, as a preferred embodiment, the following algorithm is applied. The newspaper management first determines the threshold time interval 10, TI. Next the current time is calculated, T0, 50. If the time of the content creation 20, TCC is less than the time difference T0−TCC, 40, then the content is considered recent, and the content must be published 50 within the firewall and a fee must be charged for public access. Otherwise, the content is published 50 outside of the firewall and no fee is charged for viewing.

In a preferred embodiment these time intervals are calculated daily and the units associated with all time intervals is days since 2000 years before the birth of Jesus Christ.

### BRIEF DESCRIPTION OF THE DRAWINGS

FIG. 1 shows a diagram representing a decision algorithm to determine if content is new or archival.

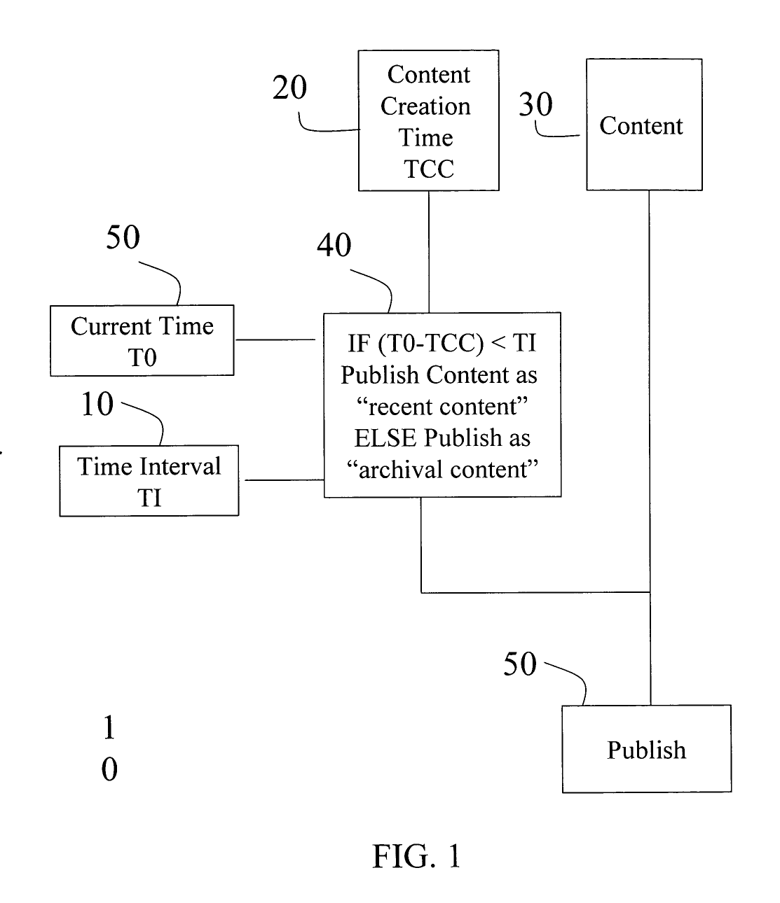

### Parts

10 Time Interval—The amount of time that must elapse before content is considered archival

20 Creation Time—The time at which content is considered to be created

30 Content—written expression of news, opinions, and curiosities associated with local, national and global events

40 Recent or Archival Classification Algorithm

50 Publishing Step

I claim:

1. An on-line news method providing users free access to archival content and access to recent content on a paid subscription basis.

2. The method of claim 1 wherein recent content is published within a specified number of days from the current date and archival content is published before the specified number of days from the current date.

3. The method of claim 2 wherein the specified number of days is seven.
